(19) United States
(12) Patent Application Publication
(10) Pub. No.: US 2014/0333739 A1
(43) Pub. Date: Nov. 13, 2014

(54) 3D IMAGE DISPLAY DEVICE AND METHOD

(71) Applicants: Jeonghyu Yang, Pyeongtaek-si (KR); Sungwook Shin, Pyeongtaek-si (KR); Jungeun Lim, Pyeongtaek-si (KR); Joohyun Lee, Pyeongtaek-si (KR); Seungkyun Oh, Pyeongtaek-si (KR); Jongchan Kim, Pyeongtaek-si (KR); Jinseok Im, Pyeongtaek-si (KR)

(72) Inventors: Jeonghyu Yang, Pyeongtaek-si (KR); Sungwook Shin, Pyeongtaek-si (KR); Jungeun Lim, Pyeongtaek-si (KR); Joohyun Lee, Pyeongtaek-si (KR); Seungkyun Oh, Pyeongtaek-si (KR); Jongchan Kim, Pyeongtaek-si (KR); Jinseok Im, Pyeongtaek-si (KR)

(73) Assignee: LG ELECTRONICS INC, Seoul (KR)

(21) Appl. No.: 14/362,244

(22) PCT Filed: Dec. 3, 2012
(86) PCT No.: PCT/KR2012/010375

§ 371 Date: Jun. 2, 2014

Related U.S. Application Data
(60) Provisional application No. 61/566,008, filed on Dec. 2, 2011.

(51) Int. Cl. H04N 13/04; G06K 9/46; H04N 13/00

(52) U.S. Cl. CPC H04N 13/0402; H04N 13/0029; G06K 9/4642; H04N 2213/007
USPC 348/54

(57) ABSTRACT

Disclosed are a device and a method for displaying a 3D image. A 3D image display device comprises: a stereo image analysis unit which receives a stereo image having a left image and a right image, and detects image information that contains edge information, color information, and/or scene change information; a first depth adjusting unit which determines a reference point by analyzing the distribution of depth of the stereo image based on the detected image information, and adjusts a three-dimensional effect of the stereo image by shifting the stereo image based on the determined reference point; a second depth adjusting unit which extracts depth map information in a pixel unit after reducing the size of the stereo image, and generates an image of a new viewpoint by warping the extracted depth map information such that the three-dimensional effect of the stereo image is adjusted; and a formatter which converts, according to a display device, the format of the stereo image having a three-dimensional effect adjusted by the first depth adjusting unit and/or the second depth adjusting unit.

### FIELD OF THE INVENTION

The present invention relates to a method and device for displaying 3D (Dimensional) images and, more particularly, to a method and device for adjusting cubic effects (or 3D effects) of 3D images by using depth information extracted from the 3D images.

### BACKGROUND ART

Generally, a 3D image is created by using principles of stereo (or stereoscopic) vision of both human eyes. Binocular parallax is a crucial factor providing 3D effect (or cubic effect), and, when both left and right eyes respectively view a flat image, the human brain may combine the two different images, thereby being capable of reproducing the genuine 3D effect (or also referred to as depth effect) and real-live effect of the 3D image. Herein, the binocular parallax refers to a parallax occurring between two eyes and, more specifically, to a difference between what is viewed by the left eye and what is viewed by the right eye, which may occur due to distance between the two eyes being spaced apart from one another by approximately 65 mm. More specifically, due to a difference in the image shown to the left eye and the image shown to the right eye, the 3D image is recognized volumetrically by the human brain. In order to do so, the 3D image display device creates a difference between the image shown to the left eye and the image shown to the right eye by using diverse methods.

Additionally, methods showing 3D images include a glasses type and a non-glasses type. Herein, the glasses type is then categorized as a passive method and an active method. The passive method corresponds to a method of differentiating the display of a left image and a right image by using a polarized filter. More specifically, the passive method corresponds to a method of viewing a 3D image by wearing glasses configured of a blue lens and a red lens respective to each eye. The active method corresponds to a method of differentiating a left image and a right image by sequentially and alternately covering the left eye and the right eye at predetermined time intervals. More specifically, the active method corresponds to periodically repeating a time-divided (or time split) image and viewing the image while wearing a pair of glasses equipped with an electronic shutter synchronized with the cycle period of the repeated time-divided image, and the active method may also be referred to as a time split type (or method) or a shutter glasses type (or method). The non-glasses type corresponds to a method that differently creates the images respectively shown to both eyes by placing a special device in from the of the display device. The most typical non-glasses type includes a lenticular type, wherein a lenticular lens plate having cylindrical lens arrays perpendicularly aligned thereon is installed at a fore-end portion of an image panel, and a parallax barrier type, wherein a barrier layer having periodic slits is equipped to an upper portion of an image panel.

As described above, the 3D image display device creates a 3D effect by maximizing the usage of the principle of binocular depth. More specifically, the 3D image display device splits the left/right image, which is displayed in a time-spatial interleaving format within the display and respectively provided to the left eye and the right eye by using polarized glasses or shuttered glasses. At this point, the size of the sensed 3D effect may vary depending upon the size of the parallax, and, herein, even if the same image is being displayed, the size of a physical parallax varies depending upon the display size. Additionally, even if the parallax is the same, individual derivation respective to the 3D effect may exist depending upon the distance between the pupils of each individual.

Therefore, in order to allow a 3D image display device to provide 3D image services to a user, the provision of a means enabling the 3D effect to be adjusted to best fit the user's personal preferences (or taste) with respect to such variables is being required.

### DETAILED DESCRIPTION OF THE INVENTION

### Technical Objects

In order to resolve the above-described problems, an object of the present invention is to provide a 3D image display device and method that can adjust 3D effects (or cubic effects) of 3D images.

Another object of the present invention is to provide a 3D image display device and method that can adjust 3D effects (or cubic effects) of 3D images to best fit a user's personal preferences.

### Technical Solutions

In order to achieve the above-described technical object, according to an exemplary embodiment, a 3D image display device includes a stereo image analyzing unit configured to receive a stereo image that is composed of a left image and a right image and to detect image information including at least one of edge information, color information, and scene change information, a first depth adjusting unit configured to decide a reference point by analyzing a depth distribution of the stereo image based upon the detected image information, and to adjust 3D effect of the stereo image by shifting the stereo image based upon the decided reference point, a second depth adjusting unit configured to extract depth map information in pixel units after reducing a size of the stereo image, and to adjust 3D effect of the stereo image by warping the extracted depth map information and generating a new viewpoint image, and a formatter configured to convert a format of a stereo image having its 3D effect adjusted to best fit the display device, wherein the stereo image having its 3D effect is adjusted by at least one of the first depth analyzing unit and the second depth analyzing unit.

According to the exemplary embodiment, the stereo image analyzing unit configures multiple level images by sequentially reducing the stereo image to predetermined sizes, and the stereo image analyzing unit detects the image information including at least one of the edge information, the color information, and the scene change information from at least one level image of the multiple level images.

According to the exemplary embodiment, the first depth adjusting unit includes a depth distribution analyzing unit configured to configure a depth histogram indicating depth distribution of the stereo image by extracting feature corresponding points respective to the left image and the right image within the stereo image based upon the image information, and to decide the reference point from the depth histogram, and an image shift adjusting unit configured to adjust 3D effect of the stereo image by shifting the stereo image based upon the decided reference point.

According to the exemplary embodiment, the depth distribution analyzing unit receives the depth map information in pixel units from the second depth adjusting unit, so as to configure the depth histogram indicating depth distribution of the stereo image, and the depth distribution analyzing unit decides the reference point from the depth histogram.

According to the exemplary embodiment, the image shift adjusting unit includes a depth range analyzing unit configured to add weight of a depth statistics value of a previous frame to the reference point decided by the depth distribution analyzing unit, thereby reconfiguring the reference point, and a shift value calculation unit configured to shift the stereo image, after calculating a shift value according to which the stereo image is to be shifted based upon the reconfigured reference point and depth level.

According to the exemplary embodiment, the depth level is set up by a user through a user interface (UI), or the depth level is automatically set up by the 3D image display device.

According to the exemplary embodiment, the image shift adjusting unit shifts the stereo image within a predetermined reference depth range, when the stereo image deviates from the predetermined reference depth range.

According to the exemplary embodiment, the second depth adjusting unit includes a depth map extraction unit configured to estimate depth map information for each pixel from a stereo image corresponding to a level lower than a resolution of an original image and to up-sample the depth map information to the resolution of the original image, and a new viewpoint image synthesis unit configured to generate the new viewpoint image by warping the depth map information.

According to the exemplary embodiment, the depth map extraction unit includes a pre-processor configured to estimate a search range by estimating depth map information of each pixel from a second level stereo image, a base depth estimation unit configured to estimate base depth map information of each pixel from a first level stereo image within the estimated search range, and an enhanced depth estimation unit configured to up-sample the base depth map information to the resolution of the original image.

According to the exemplary embodiment, the new viewpoint image synthesis unit includes a warping unit configured to warp the depth map information in accordance with depth levels, and to generate the new viewpoint image based upon the warped depth map information, a hole filling unit configured to fill holes generated during the warping process, and a boundary handling unit configured to remove hole regions generated at a boundary of the new viewpoint image.

According to an exemplary embodiment, a 3D image display method according to the present invention includes a stereo image analyzing step receiving a stereo image that is composed of a left image and a right image and detecting image information including at least one of edge information, color information, and scene change information, a first depth adjusting step deciding a reference point by analyzing a depth distribution of the stereo image based upon the detected image information, and adjusting 3D effect of the stereo image by shifting the stereo image based upon the decided reference point, a second depth adjusting step extracting depth map information in pixel units after reducing a size of the stereo image, and adjusting 3D effect of the stereo image by warping the extracted depth map information and generating a new viewpoint image, and a format converting step converting a format of a stereo image having its 3D effect adjusted to best fit the display device, wherein the stereo image having its 3D effect is adjusted by at least one of the first depth analyzing step and the second depth analyzing step.

Other technical objects, features, and advantages of the present invention will become apparent by the detailed description of the exemplary embodiments referring to the accompanying drawings.

### Effects of the Invention

In the present invention, the 3D effect of a 3D image is adjusted by analyzing the distribution of depth values from a 3D input image and by shifting at least one of left/right images based upon the analyzed result, or the 3D effect of a 3D image is adjusted by extracting a depth map from a 3D input image and by synthesizing a new viewpoint image based upon the extracted depth map. Thus, the 3D effect of the 3D image may be adjusted without distortion. Most particularly, by enabling the user to select a depth level to which he (or she) wishes to perform adjustment through a user interface (UI), the 3D effect of the 3D image may be adjusted to best fit the user's preference (or taste).

Additionally, by allowing the depth of the 3D image to be automatically adjusted, in case the depth of a 3D image deviates from a predetermined range, a safe viewing condition of the 3D image may be satisfied, thereby reducing visual fatigue of the user, which may occur during the viewing of the 3D image.

### BRIEF DESCRIPTION OF THE DRAWINGS

FIG. 1 illustrates a block diagram showing a general structure of a 3D image display device according to an exemplary embodiment of the present invention.

FIG. 2 illustrates a block diagram showing a structure of a depth controller of the 3D image display device according to an exemplary embodiment of the present invention.

FIG. 3 illustrates a block diagram showing a structure of a depth controller of the 3D image display device according to another exemplary embodiment of the present invention.

FIG. 4 illustrates a block diagram showing a structure of a depth controller of the 3D image display device according to yet another exemplary embodiment of the present invention.

FIG. 5 illustrates a detailed block diagram showing a stereo image analyzing unit according to an exemplary embodiment of the present invention.

FIG. 6 illustrates a detailed block diagram showing a depth distribution analyzing unit according to an exemplary embodiment of the present invention.

FIG. 7a illustrates an exemplary left image according to the present invention.

FIG. 7b illustrates an exemplary right image according to the present invention.

FIG. 7c illustrates an exemplary feature corresponding point obtained from the left image of FIG. 7a and the right image of FIG. 7b.

FIG. 7d illustrates exemplary depth map information extracted in pixel units from a depth map extraction unit according to the present invention.

FIG. 7e illustrates an exemplary depth histogram configured in a depth histogram unit according to the present invention.

FIG. 8 illustrates a detailed block diagram of an image shift adjusting unit according to an exemplary embodiment of the present invention.

FIG. 9 illustrates an exemplary shifting of an image in the image shift adjusting unit according to the present invention.

(a) of FIG. 10 to (c) of FIG. 10 illustrate other shifting examples of an image in the image shift adjusting unit according to the present invention.

FIG. 11 illustrates a detailed block diagram showing a depth map extraction unit according to an exemplary embodiment of the present invention.

FIG. 12 illustrates a detailed block diagram showing a base depth estimation unit according to an exemplary embodiment of the present invention.

FIG. 13 illustrates a detailed block diagram showing an enhanced depth estimation unit according to an exemplary embodiment of the present invention.

FIG. 14 illustrates a detailed block diagram showing a new viewpoint image synthesis unit according to an exemplary embodiment of the present invention.

FIG. 15 illustrates an example of boundary handling when performing a new viewpoint image synthesis according to the present invention.

FIG. 16 illustrates a block diagram showing a hardware configuration, when realizing the present invention as an ASIC.

(a), (b) of FIG. 17 illustrate exemplary configuration in an ASIC according to the present invention.

FIG. 18 illustrates a flow chart showing a method of adjusting 3D effect of a stereo image in a 3D image display device according to an exemplary embodiment of the present invention.

(a) of FIG. 19 to (f) of FIG. 19 illustrate an exemplary scenario for executing a depth adjusting UI in the 3D image display device according to the present invention.

(a) of FIG. 20 to (f) of FIG. 20 illustrate another exemplary scenario for executing a depth adjusting UI in the 3D image display device according to the present invention.

### BEST MODE FOR CARRYING OUT THE PRESENT INVENTION

Hereinafter, preferred exemplary embodiments of the present invention that can best carry out the above-described objects of the preset invention will be described in detail with reference to the accompanying drawings. At this point, the structure or configuration and operations of the present invention, which are illustrated in the drawings and described with respect to the drawings, will be provided in accordance with at least one exemplary embodiment of the present invention. And, it will be apparent that the technical scope and spirit of the present invention and the essential structure and operations of the present invention will not be limited only to the exemplary embodiments set forth herein.

In addition, although the terms used in the present invention are selected from generally known and used terms, the terms used herein may be varied or modified in accordance with the intentions or practice of anyone skilled in the art, or along with the advent of a new technology. Alternatively, in some particular cases, some of the terms mentioned in the description of the present invention may be selected by the applicant at his or her discretion, the detailed meanings of which are described in relevant parts of the description herein. Furthermore, it is required that the present invention is understood, not simply by the actual terms used but by the meaning of each term lying within.

Specific structural and functional description of the present invention respective to the exemplary embodiments, which are provided in accordance with the concept of the present invention disclosed in the description of the present invention, is merely an exemplary description provided for the purpose of describing the exemplary embodiments according to the concept of the present invention. And, therefore, the exemplary embodiment of the present invention may be realized in diverse forms and structures, and, it should be understood that the present invention is not to be interpreted as being limited only to the exemplary embodiments of the present invention, which are described herein.

Since diverse variations and modifications may be applied to the exemplary embodiments according to the concept of the present invention, and, since the exemplary embodiments of the present invention may be configured in diverse forms, specific embodiment of the present invention will hereinafter be described in detail with reference to the examples presented in the accompanying drawings. However, it should be understood that the exemplary embodiments respective to the concept of the present invention will not be limited only to the specific structures disclosed herein. And, therefore, it should be understood that all variations and modifications, equivalents, and replacements, which are included in the technical scope and spirit of the present invention, are included.

Additionally, in the present invention, although terms such as first and/or second may be used to describe diverse elements of the present invention, it should be understood that the elements included in the present invention will not be limited only to the terms used herein. The above-mentioned terms will only be used for the purpose of differentiating one element from another element, for example, without deviating from the scope of the present invention, a first element may be referred to as a second element, and, similarly, a second element may also be referred to as a first element.

In the present invention, 3D images may include stereo (or stereoscopic) images based on two views, multi-view images based on more than three views, and so on.

The stereo image refers to a pair of left and right images, which is acquired by respectively filming (or recording or capturing) an identical object from an left-side camera and a right-side camera each being spaced apart from one another at a predetermined distance. The multi-view image refers to 3 or more images respectively acquired from 3 or more different cameras, each filming (or recording) the same object from a predetermined distance or at a predetermined angle.

Although a stereo image will be given as an example of the embodiment of the present invention, it will be apparent that the multi-view image can also be applied to the present invention.

A transmission format of the stereo image may include a single video stream format and a multi video stream format.

The single view stream format includes side by side, top/bottom, interlaced, frame sequential, checker board, anaglyph, and so on.

The multi video stream format includes Full left/right, Full left/Half right, 2D video/depth, and so on.

For example, the side by side format corresponds to a case, wherein a left image and a right image are each ½ sub-sampled along a horizontal direction, and wherein a sampled left image is positioned on the left side and a sampled right image is positioned on the right side, thereby creating a single stereo image. Additionally, the top/bottom format corresponds to a case, wherein a left image and a right image are each ½ sub-sampled along a vertical direction, and wherein the left image is positioned on the upper side and the right image is positioned on the lower side, thereby creating a single stereo image. The interlaced format corresponds to a case, wherein a left image and a right image are each ½ sub-sampled along a horizontal direction, and wherein each pixel of the sampled left image and each pixel of the sample right image are aligned to be alternated one by one, thereby creating a single stereo image.

The present invention relates to extracting depth information from a 3D image and adjusting 3D effect of the 3D image. According to an exemplary embodiment, the present invention relates to having a user adjust the 3D effect of a 3D image through a User Interface (UI). According to another exemplary embodiment, the present invention relates to automatically adjusting the 3D effect of the 3D image, in case the depth of the 3D image deviates from a predetermined range. According to yet another exemplary embodiment, the present invention relates to having a user adjust the 3D effect of a 3D image through a UI and, at the same time, to automatically adjusting the 3D effect of the 3D image, in case the depth of the 3D image deviates from a predetermined range.

According to an exemplary embodiment of the present invention, adjusting the 3D effect of a 3D image by analyzing the distribution of depth values from a 3D input image and by shifting at least one of left/right images based upon the analyzed result will hereinafter be described.

According to another exemplary embodiment of the present invention, adjusting the 3D effect of a 3D image by extracting a depth map from a 3D input image and by synthesizing (or generating) a new viewpoint image based upon the extracted depth map will hereinafter be described.

In the present invention, depth or disparity refers to a distance between left/right images, and such depth allows the user to sense a 3D effect when viewing an image. More specifically, due to a depth between the left image and the right image, the user feels a parallax between both of his (or her) eyes, and such binocular parallax allows the user to sense the 3D effect. In other words, a correlation exists between depth and parallax.

The binocular parallax, which is sensed by the user when viewing a cubic image, such as a 3D image, includes three different types, such as a negative parallax, a positive parallax, and a zero parallax. The negative parallax corresponds to a case when an object included in the image appears to be protruding from the screen. And, the positive parallax corresponds to a case when an object included in the image appears to be sinking into the screen, and the zero parallax corresponds to a case when the object included in the image appears to be placed in the same depth as the screen.

Generally, in a cubic image, although the negative parallax has a greater 3D effect as compared to the positive parallax, since the convergence angle between both eyes is greater in the negative parallax, as compared to the positive parallax, the positive parallax provides greater viewing comfort for both eyes. However, even though the positive parallax provides comfortable viewing, the eyes of the user may sense viewing fatigue if the objects within the cubic image only have positive parallax. Similarly, the eyes of the user may sense viewing fatigue if the objects within the cubic image only have negative parallax.

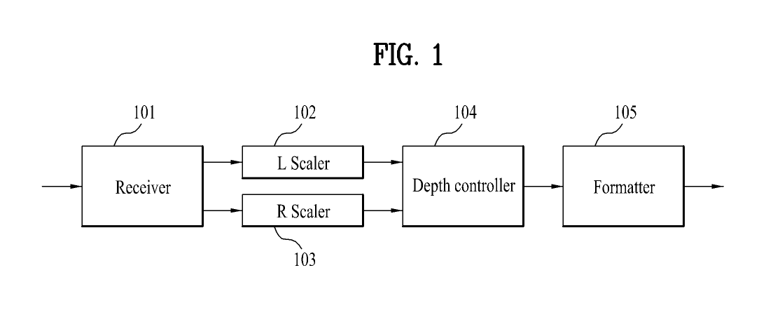

FIG. 1 illustrates a block diagram showing a general structure of a 3D image display device according to an exemplary embodiment of the present invention, and, therein, the 3D image display device includes a receiver (101), a left image processing unit (102), a right image processing unit (103), a depth controller (104), and a formatter (105).

In the present invention, the 3D image display device may correspond to a digital television, a set-top box, and so on. Additionally, the 3D image display device may also corresponds to a mobile terminal (or user equipment), such as a mobile phone, a smart phone, a digital broadcasting terminal (or user equipment), a PDA (Personal Digital Assistants), a PMP (Portable Multimedia Player), a navigation, and so on, and the 3D image display device may also correspond to a personal computer system, such as a desktop, a laptop (or notebook), a tablet or a handheld computer, and so on.

Additionally, as shown in FIG. 1, according to an exemplary embodiment of the present invention, the receiver (101) corresponds to a broadcast receiver. In this case, the receiver (101) may include a tuner, a demodulator, a decoder, and so on. More specifically, the tuner receives a channel that is selected by the user, and the demodulator demodulates a broadcast signal of the received channel. The decoder decodes the demodulated broadcast signal and recovers the signal to a state prior to compression. At this point, in case the demodulated broadcast signal corresponds to a 3D image signal, the decoder decodes the broadcast signal in accordance with the transmission format, so as to output a left image and a right image. For example, if the transmission format corresponds to the side by side format, pixels located on a left-side half of a frame are decoded and outputted as a left image, and pixels located on a right-side half of the frame are decoded and outputted as a right image. At this point, an opposite case is also possible. In another example, if the transmission format corresponds to the top/bottom format, pixels located on an upper half of the frame are decoded and outputted as a left image, and pixels located on a lower half of the frame are decoded and outputted as a right image. At this point, an opposite case is also possible. Thereafter, the left image is outputted to the left image processing unit (102), and the right image is outputted to the right image processing unit (103).

The left image processing unit (102) is also referred to as a left image scaler (L scaler), and, after scaling the inputted left image to best fit a resolution or predetermined screen ratio of the display device, the left image processing unit (102) outputs the scaled left image to the depth controller (104).

The right image processing unit (103) is also referred to as a right image scaler (R scaler), and, after scaling the inputted right image to best fit a resolution or predetermined screen ratio of the display device, the right image processing unit (103) outputs the scaled right image to the depth controller (104).

The display device is manufactured to display an image screen having a predetermined resolution with respect to each product specification, e.g., 720×480 format, 1024×768 format, 1280×720 format, 1280×768 format, 1280×800 format, 1920×540 format, 1920×1080 format, or 4K×2K format, and so on. Accordingly, the left image processing unit (102) and the right image processing image (103) may convert the resolution of the left image and the resolution of the right image, which may be inputted in diverse values, in accordance with the resolution of the corresponding display device.

In the present invention, a combination of the left image, which is processed by the left image processing unit (102), and the right image, which is processed by the right image processing unit (103), will be referred to as a 3D input image or a stereo image.

According to an exemplary embodiment, the depth controller (104) analyzes a distribution of depth values from the 3D input image, and, by using the analyzed result, the depth controller (104) may shift the left/right images, so as to adjust the 3D effect of the 3D image, and may then output the processed image to the formatter (105).

According to another exemplary embodiment, the depth controller (104) may extract a depth map from the 3D input image, and, then, by using the extracted depth map, the depth controller (104) may synthesize a new viewpoint image, so as to adjust the 3D effect of the 3D image, and, may then output the processed image to the formatter (105).

The depth controller (104) according to the present invention may automatically adjust (or control) the 3D effect of the 3D image based upon the system design, or the depth controller (104) may also adjust the 3D effect of the 3D image in accordance with a request of the user, which is made through a UI.

The formatter (105) converts the 3D image having its 3D effect adjusted by the depth controller (104) to best fit the output format of the display device and outputs the converted image to the display device. For example, the formatter (105) also performs a function of mixing the depth-controlled (or depth-adjusted) left image and right image in line units.

The display device displays the 3D image, which is outputted from the formatter (105). The display device may correspond to a screen, a monitor, a projector, and so on. Additionally, the display device may correspond to a device that can display general 2D images, a device that can display 3D images requiring glasses, a device that can display 3D images without requiring glasses, and so on.

In FIG. 1, according to an exemplary embodiment, if the broadcast signal received by the receiver corresponds to a 2D image, only one of the left image processing unit (102) and the right image processing unit (103) is activated, and the depth controller (104) is bypassed.

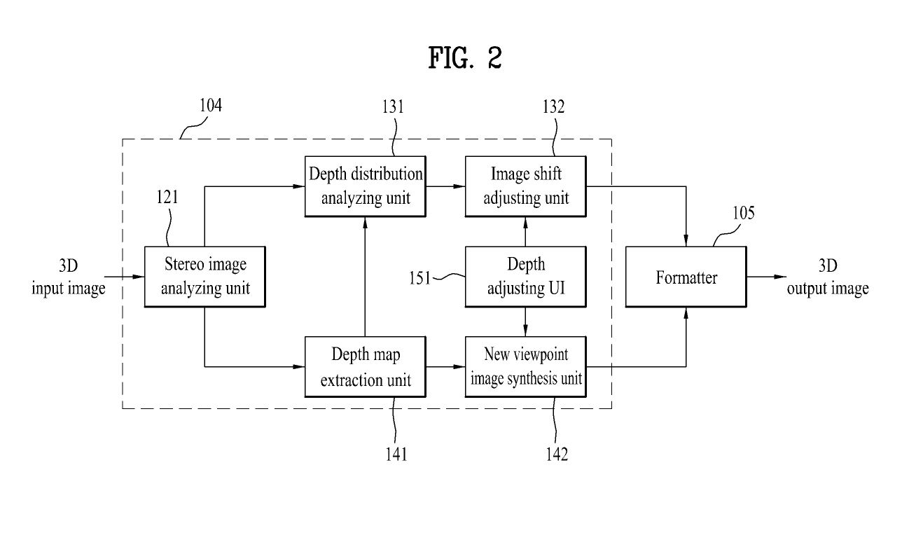

FIG. 2 illustrates a detailed block diagram of the depth controller (104) of FIG. 1 according to an exemplary embodiment, and, herein, the depth controller (104) may include a stereo image analyzing unit (121), a depth distribution analyzing unit (131), an image shift adjusting unit (132), a depth map extraction unit (141), a new viewpoint image synthesis unit (142), and a depth adjusting UI unit (151).

In the present invention, the depth distribution analyzing unit (131) and the image shift adjusting unit (132) will be collectively referred to as a first depth adjusting unit, and the depth map extraction unit (141) and the new viewpoint image synthesis unit (142) will be collectively referred to as a second depth adjusting unit. The first depth adjusting unit and the second depth adjusting unit may be selectively operated, or, after being simultaneously operated, the formatter (105) may select any one of the first depth adjusting unit and the second depth adjusting unit. Any one of the first depth adjusting unit and the second depth adjusting unit may be automatically selected by the 3D image display device or may be selected by the user through UI. Additionally, according to the exemplary embodiment, the 3D input image corresponds to a stereo image configured of a left image and a right image. The stereo image is inputted to the stereo image analyzing unit (121).

The stereo image analyzing unit (121) analyzes basic image information from the inputted stereo image and then outputs the analyzed information to the depth distribution analyzing unit (131) and the depth map extraction unit (141).

The depth distribution analyzing unit (131) analyzes depth distribution of the left image and the right image both included in the stereo image, based upon at least one of the image information analyzed by the stereo image analyzing unit (121) and the depth map information extracted by the depth map extraction unit (141), and, then, after obtaining a reference point, the reference point is outputted to the image shift adjusting unit (132).

The image shift adjusting unit (132) shifts at least one of the left image and the right image based upon a depth level, which is decided by the user or by the 3D image display device, and the reference point, which is outputted from the depth distribution analyzing unit (131), thereby adjusting the depth of the stereo image. More specifically, the image shift adjusting unit (132) controls the depth of the image in frame units, so as to adjust the 3D effect.

After extracting depth map information of the left image and the right image, which are included in the stereo image, the depth map extraction unit (141) outputs the extracted result to the depth distribution analyzing unit (131) and the new viewpoint image synthesis unit (142).

At this point, according to the exemplary embodiment, in order to reduce the image processing load and to use broader neighboring region information with respect to the same processing block size, the depth map extraction unit (141) receives an image corresponding to a down-sized version of the inputted stereo image from the stereo image analyzing unit (121), thereby extracting depth map information. More specifically, by reducing the size of the image, a calculation amount is reduced, and realization becomes more enhanced, and broader neighboring region information with respect to the same processing block size may be used. In order to do so, the stereo image analyzing unit (121) may sequentially reduce the inputted stereo image to predetermined sizes, so as to configure image layers (or image hierarchy). The depth map information refers to distance information per pixel based upon a Z axis within the screen. For example, when it is assumed that the screen is set to 0, the depth map information indicates how much each pixel is pulled out (+) and how much each pixel is pushed in (−) within the corresponding image.

By generating an image of a new viewpoint (or new viewpoint image) based upon a depth level, which is decided by the user or by the 3D image display device, depth map information, which is extracted by the depth map extraction unit (141), and the original image, the new viewpoint image synthesis unit (142) adjusts the depth of the stereo image. More specifically, the new viewpoint image synthesis unit (142) controls the depth of the image in pixel units, thereby adjusting the 3D effect.

The depth adjusting UI unit (151) may be provided in the form of a menu, and the user may use a remote controller or a key input unit, which is attached to the 3D image display device, so as to enter the menu providing the depth adjusting UI. The user may select a depth level for adjusting the 3D effect of the 3D image through the depth adjusting UI unit (151). FIG. 2 shows an example wherein the first depth adjusting unit and the second depth adjusting unit are both realized in the 3D image display device.

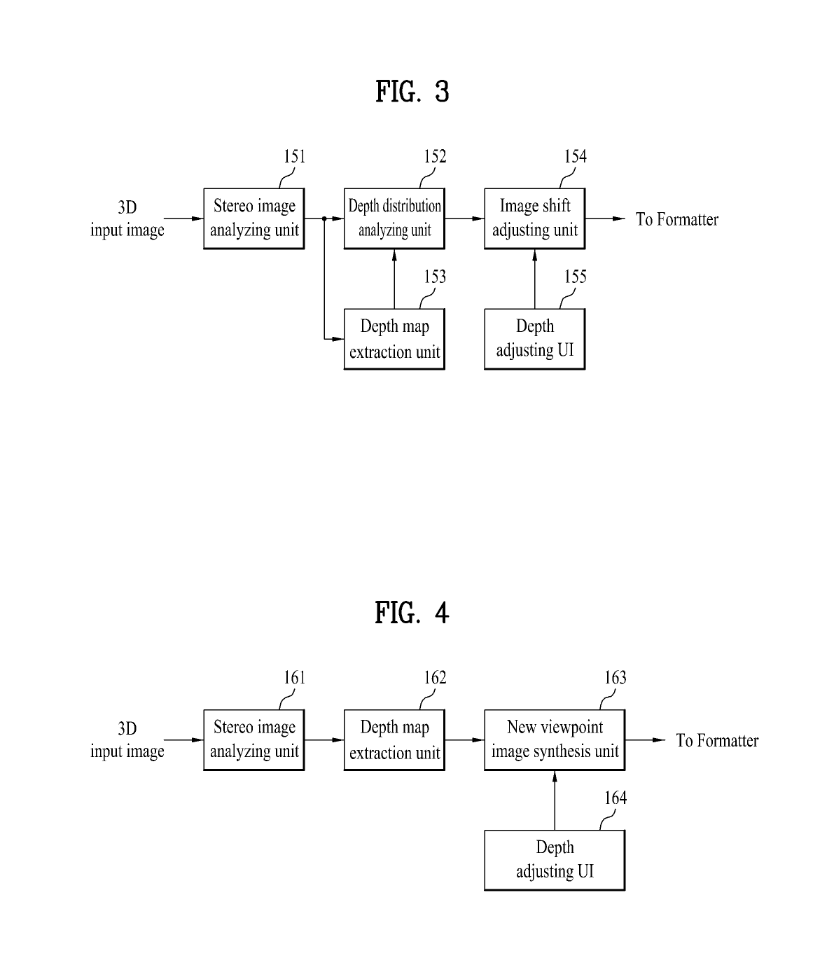

FIG. 3 illustrates a block diagram showing a structure of a depth controller of the 3D image display device according to another exemplary embodiment of the present invention, and, most particularly, FIG. 3 shows an example wherein only the first depth adjusting unit is realized in the 3D image display device. More specifically, in FIG. 3, the 3D image display device includes a stereo image analyzing unit (151), a depth distribution analyzing unit (152), a depth map extraction unit (153), an image shift adjusting unit (154), and a depth adjusting UI unit (155). Since the operations of each element of FIG. 3 are identical to the description of the operations of the same blocks of FIG. 2, reference may be made to FIG. 2, and, therefore, detailed description of the same will be omitted herein. Additionally, in FIG. 3, the depth map extraction unit (153) is optional.

FIG. 4 illustrates a block diagram showing a structure of a depth controller of the 3D image display device according to yet another exemplary embodiment of the present invention, and, most particularly, FIG. 4 shows an example wherein only the second depth adjusting unit is realized in the 3D image display device. More specifically, in FIG. 4, the 3D image display device includes a stereo image analyzing unit (161), a depth map extraction unit (162), a new viewpoint image synthesis unit (163), and a depth adjusting UI unit (164). Since the operations of each element of FIG. 4 are identical to the description of the operations of the same blocks of FIG. 2, reference may be made to FIG. 2, and, therefore, detailed description of the same will be omitted herein.

Hereinafter, the detailed operations of each element in the 3D image display device of FIG. 2 to FIG. 4 will be described. Blocks having the same name in FIG. 2 to FIG. 4 perform the same operations. However, for simplicity in the description, the operations of each element will be described with reference to the reference numerals of FIG. 2.

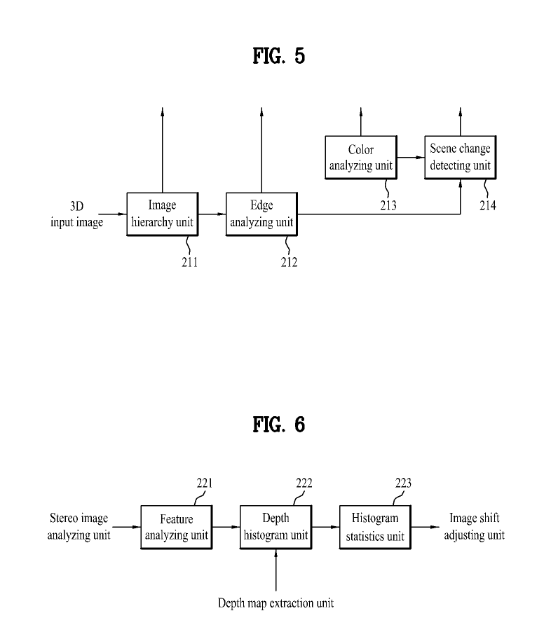

FIG. 5 illustrates a detailed block diagram showing a stereo image analyzing unit (121) according to an exemplary embodiment, and, herein, the stereo image analyzing unit (121) may include an image hierarchy unit (211), an edge analyzing unit (212), a color analyzing unit (213), and a scene change detecting unit (214).

The stereo image analyzing unit (121) sequentially reduces the original resolution stereo image to 2-N, so as to generate multiple level images, thereby detecting image information, such as edge information, color information, and scene change information, from the images corresponding to each level. At least one of the detected edge information, color information, and scene change information mentioned above is outputted to the depth distribution analyzing unit (131) and the depth map extraction unit (141) along with the images corresponding to each level.

More specifically, the image hierarchy unit (211) of the stereo image analyzing unit (121) configures an image hierarchy by reducing the size of the inputted stereo image. For example, an image hierarchy may be configured by sequentially generating an image, which is reduced by ½ both horizontally/vertically with respect to the inputted stereo image. In the present invention, the original resolution image (i.e., original image) will be referred to as Level 0 (or Level 0 image), and the image reduced by 2-N both horizontally/vertically will be referred to as Level N (or Level N image). More specifically, an image corresponding to the original resolution image reduced by ½ both horizontally/vertically will be referred to a Level 1 (or Level 1 image), and an image corresponding to the image of Level 1 being reduced by ½ horizontally/vertically will be referred to as Level 2 (or Level 2 image). Additionally, such Level ON images will be referred to as the image hierarchy. The images of each level, which are configured by the image hierarchy unit (211), are outputted to the depth distribution analyzing unit (131) and the depth map extraction unit (141). Furthermore, the images of each level is outputted to at least one of the edge analyzing unit (212), the color analyzing unit (213), and the scene change detecting unit (214) within the stereo image analyzing unit (121).

The edge analyzing unit (212) extracts edge information from at least one level image. According to an exemplary embodiment of the present invention, a 3×3 sobel filter is used in order to detect the edge information. Based upon a pixel for obtaining the edge, the 3×3 sobel filter allocates another filter coefficient along a direction that is to be obtained with respect to a 3×3 neighboring block. More specifically, as a non-linear operator, the 3×3 sobel filter first calculates a difference in the sum of the pixels belonging to both ends within a mask window region, and, then, by calculating an average size of the calculated difference with respect to the horizontal and vertical directions, the edge portion may be emphasized.

The color analyzing unit (213) extracts color information from at least one level image. At this point, in case each of R/G/B is assigned with 8 bits, the total number of color combinations is equal to 224. The color analyzing unit (213) performs color segmentation in order to use a color distribution feature by grouping similar colors. Additionally, a process of analyzing and correcting colors of the left/right images may also be performed.

The scene change detecting unit (214) detects a scene change from a sequence of at least one level image. More specifically, an image sequence consists of a series of scenes, and a correlation may exist in an image characteristic (or image feature) or 3D depth between the image frames within the same scene. Therefore, the scene change detecting unit (214) outputs scene change information after detecting a point where a scene changes (or a scene changing point) from an image sequence of at least one level.

At least one of the edge information extracted from the edge analyzing unit (212), the color information extracted from the color analyzing unit (213), and the scene change information detected from the scene change detecting unit (214) is outputted to the depth distribution analyzing unit (131) and the depth map extraction unit (141).

FIG. 6 illustrates a detailed block diagram showing a depth distribution analyzing unit (131) according to an exemplary embodiment, and, herein, the depth distribution analyzing unit (131) may include a feature analysis unit (221), a depth histogram unit (222), and a histogram statistics unit (223).

The depth distribution analyzing unit (131) configures a depth value histogram and deduces diverse statistics. More specifically, the depth distribution analyzing unit (131) analyzes to which position objects are distributed based on a screen. In other words, the depth distribution analyzing unit (131) analyzes a distribution ratio of pixels for each depth with respect to one frame.

In order to do so, the feature analysis unit (221) of the depth distribution analyzing unit (131) extracts a feature of the stereo image by using the at least one level image and image information (e.g., at least one of edge information, color information, and scene change information), which are outputted from the stereo image analyzing unit (104), and, by using the extracted feature, the feature analysis unit (221) obtains a feature corresponding point respective to the left/right images. For example, the feature analysis unit (221) extracts features of the edge/corner and so on, and, by using the extracted features, the feature analysis unit (221) obtains a feature corresponding point respective to the left/right images (i.e., the stereo image).

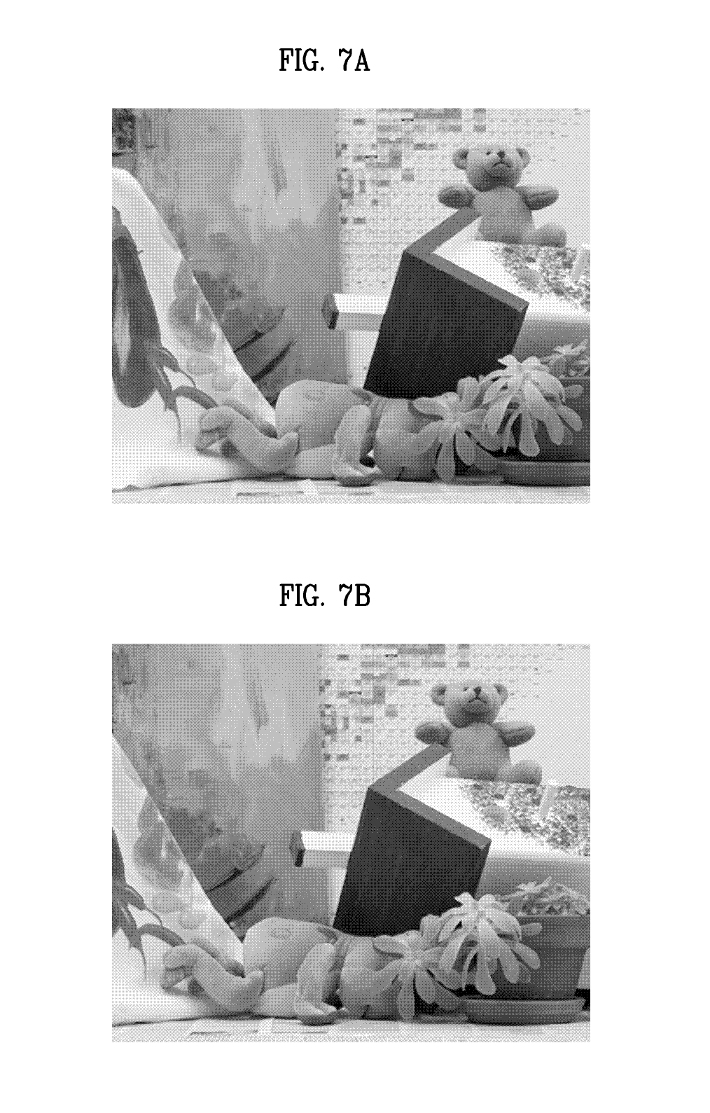

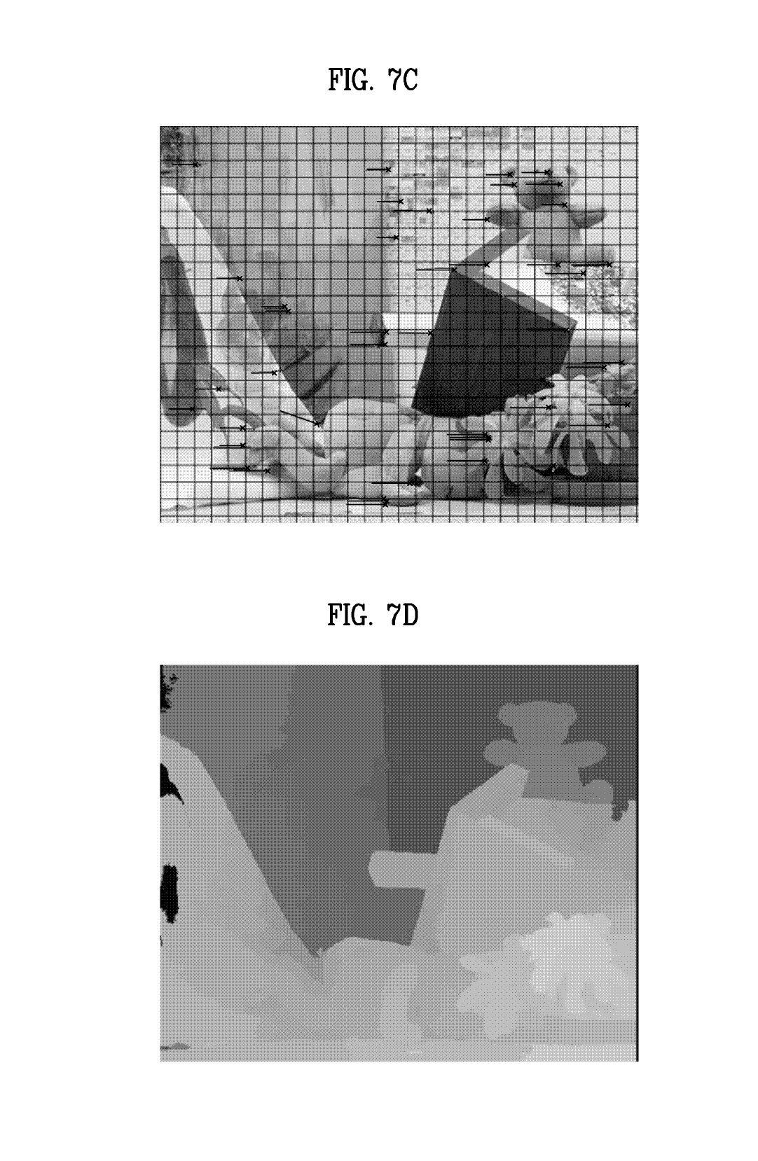

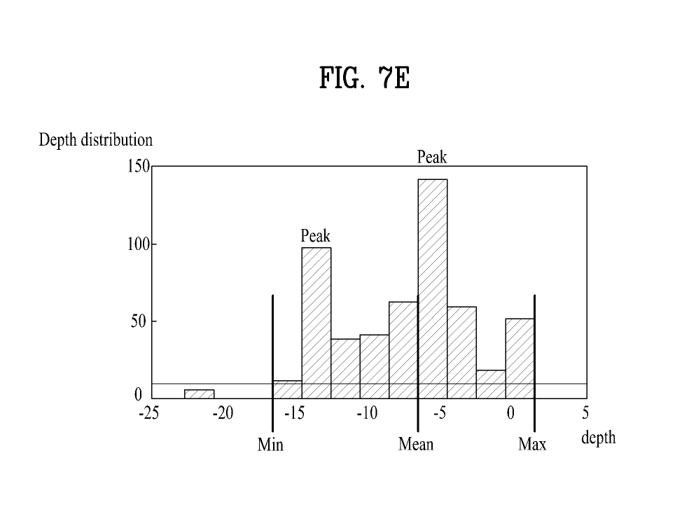

FIG. 7a illustrates an example of the left image, and FIG. 7b illustrates an example of the right image. Referring to FIG. 7a and FIG. 7b, the left image is moved slightly more to the left side as compared to the right image. In other words, this corresponds to an example when an object protrudes outside of the screen.

FIG. 7c illustrates an exemplary feature corresponding point, which is obtained from the left image of FIG. 7a and the right image of FIG. 7b.

More specifically, in the left image and the right image, feature corresponding points indicating the same points (or pin-point positions) of an object are shown to be horizontally spaced apart from one another in the left/right images. At this point, the degree of being spaced apart (parallax) varies depending upon the depth level. For example, in case an object protrudes outside of the screen, the feature corresponding point of the left image is positioned more to the right side as compared to the feature corresponding point of the right image. And, conversely, in case an object sinks into the screen, the feature corresponding points are located in opposite positions. In FIG. 7c, the degree of the being spaced apart between the left image and the right image is indicated by a bold solid line, and x marked on the right side end of the bold solid line indicates the feature corresponding point extracted from the left image. Conversely, a left side end of the bold solid line indicates the feature corresponding point extracted from the right image. At this point, if the feature corresponding point extracted from the left image coincides (or aligns) with the feature corresponding point extracted from the right image, the object is located on the screen, as the degree of being spaced apart becomes larger, i.e., as the bold solid line becomes longer, the image is located further away from the screen, and the object either protrudes outside of the screen or sinks into the screen.

FIG. 7d illustrates exemplary depth map information extracted in pixel units from the depth map extraction unit (141). More specifically, the depth map information includes distance information of each pixel based upon the Z-axis within the screen.

The depth histogram unit (222) configures a depth histogram by using depth values of the features (i.e., feature corresponding points) being outputted from the feature analysis unit (221), or by using pixel-unit depth values (distance information of each pixel) extracted from the depth map extraction unit (141). The histogram statistics unit (223) obtains diverse statistics from the depth histogram and obtains a reference point for shifting an image in the image shift adjusting unit (132) by using the obtained statistics.

FIG. 7e illustrates an exemplary depth histogram configured in the depth histogram unit (222), and the histogram statistics unit (223) obtains diverse statistics by using the configured depth histogram. In the depth histogram of FIG. 7e, the horizontal axis indicates the depth, and the vertical axis indicates the depth distribution. In the present invention, the histogram statistics may include a minimum (Min) depth, a maximum (Max) depth, a Mean depth, a peak for each depth, and so on. Herein, the peak of each depth may correspond to a number of pixels within the corresponding depth. For example, in the minimum depth of FIG. 7e, it may be known that approximately 75 pixels exist. FIG. 7e indicates that the depth distribution is concentrated along the (−) direction. In case the depth distribution is concentrated along the (−) or (+) direction, when viewing a 3D image, the user may easily feel a sense of fatigue. If the depth distribution is positioned close to Point 0, a more comfortable 3D effect may be provided. Conversely, if the depth distribution is positioned further away from Point 0, the sense of fatigue may be increased yet a more lively 3D effect may be provided. Therefore, in the present invention, the user may position the 3D image closer to Point 0 or may position the 3D image further away from Point 0 through the UI. More specifically, when the user selects a depth level through the depth adjusting UI unit (151), the image shift adjusting unit (132) may shift the 3D image so as to position the 3D image closer to Point 0 or further away from Point 0 in accordance with depth level, which is selected by the user, based upon the reference point. According to another exemplary embodiment, the 3D image display device may also automatically position the 3D image closer to Point 0 or may position the 3D image further away from Point 0.

At this point, if the depth distribution is obtained with respect to the entire frame (or whole frame), the depth distribution may be processed as a global feature in a later process, and, if the image is divided into blocks and the respective depth distribution is obtained for each block, the image may be adjusted in a later process after reflecting a local feature.

Additionally, according to the exemplary embodiment of the present invention, the Mean value of the histogram is set up as the reference point for shifting the image. At this point, the depth adjusting value may be obtained, so that this reference point can be positioned closer to or further away from 0, or so that the reference point can be moved along an opposite direction of the axis with respect to 0. The depth adjusting value may be set up by the user by selecting a depth level through the depth adjusting UI unit (151), or the depth adjusting value may be automatically set up by the 3D image display device.

By scaling the depth adjusting value in accordance with the depth level that is selected in the depth adjusting UI unit (151), or the depth level that is automatically set up by the 3D image display device, and by respectively shifting the left/right images along the opposite directions as much as the scaled depth adjusting value based upon the reference point, the image shift adjusting unit (132) adjusts the 3D effect of the stereo image. More specifically, the image shift adjusting unit (132) obtains a value for adjusting the distribution location of the depth value, so as to shift the left/right images

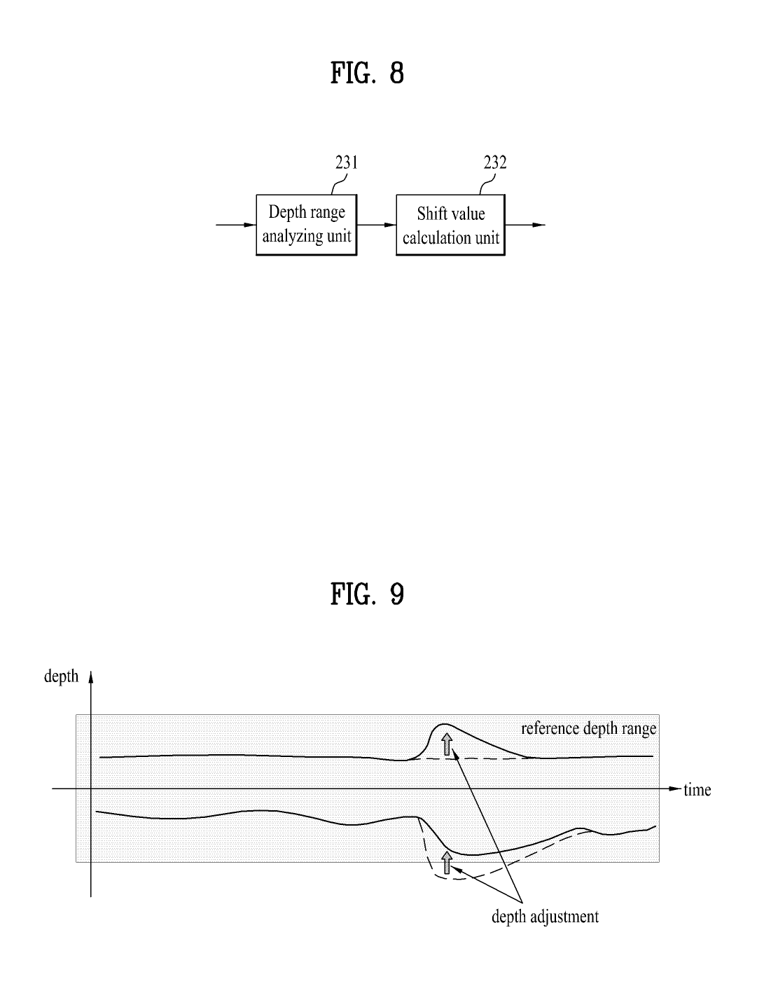

FIG. 8 illustrates a detailed block diagram of the image shift adjusting unit (132) according to an exemplary embodiment, and, herein, the image shift adjusting unit (132) may include a depth range analysis unit (231) and a shift value calculation unit (232).

The depth range analysis unit (231) reconfigures the reference point, which is obtained by the histogram statistics unit (223). At this point, the reference point may be reconfigured by adding weight to the depth statistics of the previous frame. For example, the depth range analysis unit (231) reconfigures the reference point of the depth distribution respective to the current frame based upon time-based depth range information, reference point information of the depth distribution obtained by the histogram statistics unit (223), predetermined reference depth range information, and so on. This is to allow shifting to be performed naturally on a timely basis and to allow discontinuity in the scene changes.

The shift value calculation unit (232) calculates the shift values, i.e., depth adjusting values of the left/right images based upon the depth level, which is selected by the depth adjusting UI unit (151) or automatically set up by the 3D image display device.

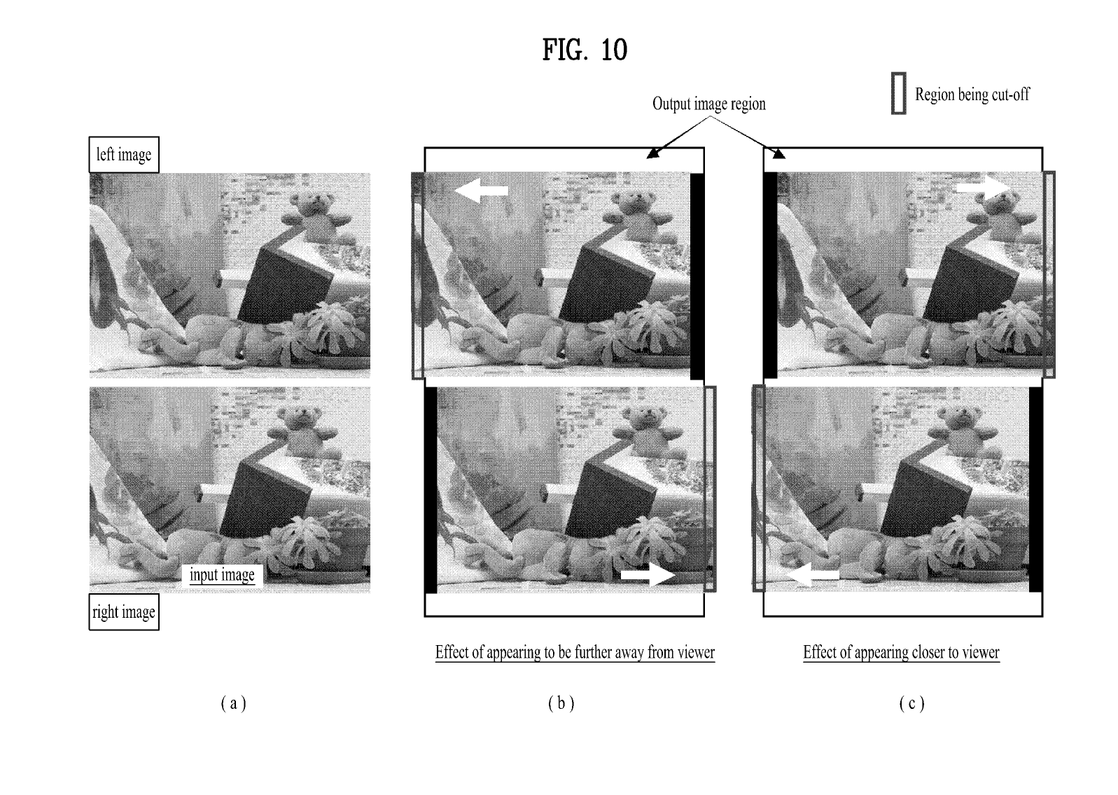

FIG. 9 illustrates exemplary operations of the image shift adjusting unit (132) according to the present invention. In FIG. 9, the dotted line indicates time-based changes in maximum/minimum values of the depth of the inputted images. The solid line indicates time-based changes occurring after the depth adjustment. And, in the drawing, the rectangular box presents a reference depth range (or also referred to as a guideline). This drawing corresponds to an example wherein the depth range of the dotted line is changed to the depth range of the solid line due to the depth adjustment. More specifically, images having the depth deviating from the reference depth range are shifted within the reference depth range. Thus, since the safe viewing condition of the 3D image can be satisfied, visual fatigue of the user, which may occur during the viewing of the 3D image, may be reduced. The operation of shifting the images having the depth deviating from the reference depth range within the reference depth range may be automatically performed by the 3D image display device. Alternatively, the user is capable of selecting on/off options through the UI, and the operation may be automatically performed only when the on option is selected.

Additionally, according to the exemplary embodiment, when performing depth range adjustment in order to obtain a smooth time-based depth change, previous depth range history is reflected.

Equation 1 shown below shows an example of calculating a depth deviation, in a case when it is assumed that the maximum depth is set up as the reference point, and when it is assumed that the depth is being adjusted based upon this reference point.

depth_deviation(t)=Max Equation 1

(current maximum depth (t)−reference maximum depth (t), 0)

In Equation 1,of the depth_deviation(t) value is to (+), this corresponds to a case when the maximum depth of the current time (t) exceeds the reference maximum depth.

At this point, according to the exemplary embodiment, the actual depth adjustment value reflects the depth deviation of a previous time, as shown below in Equation 2.

depth_adjustment(t)=w0*depth_deviation(t)+w1*depth_deviation (t−1)+ . . . +wn*depth_deviation (t−n) Equation 2

By allocating (or assigning) the weight w_k at a monotonically decreasing rate from k=0 to n, a larger weight is assigned to the depth_deviation of an image that is closer to the current image on a timely basis. If W0=1, and the remaining is equal to 0, this corresponds to a case when the depth deviation of the previous time is not reflected.

Additionally, in case of calculating depth_deviation based upon one of a maximum reference depth value and a minimum reference depth value, and in case of adjusting the depth accordingly, cases may occur when other depth values deviate from the reference value. In case the overall reference depth range cannot be satisfied, as described above, the image may be converted to 2D and displayed. Additionally, the reference depth range may be set up step-by-step. The range may be set from a Step 1 range, wherein the range is most narrow, and, as the maximum and minimum ranges are extended, the reference depth range may be set up to multiple steps, thereby allowing the depth adjustment function to be performed.

According to another exemplary embodiment, adjustments may be made, so that the reference point can be shifted to 0 or a specific value, without having to set up the reference depth range. In case the depth is concentrated either to the inner surface or to the outer surface, when an overall shifting is performed to a screen position (i.e., point when depth=0), a more comfortable 3D effect may be experienced. In case adjustment is made in an opposite direction, a greater 3D effect may be proposed. A shift value for shifting the reference point to 0 or a specific value is decided by a depth level, and the depth level may be adjusted by the user through the depth adjustment UI unit (151), and the depth level may also be forcibly adjusted by the 3D image display device. Accordingly, the shift value calculation unit (232) calculates shift values, i.e., depth adjustment values of the left/right images, based upon the reference point and the depth level. Additionally, in case the reference value is forcibly (or automatically) shifted to 0 or a specific value, the user may only select On/Off options through the UI.

(a) of FIG. 10 to (c) of FIG. 10 illustrate other shifting examples of depth adjustment operations performed by the image shift adjusting unit (132) according to the present invention. White arrows, which are marked over the left image and the right image, indicate depth adjustment amounts, and, by shifting at least one of the left image and the right image as much as the depth adjustment amount, the depth effect (i.e., 3D effect) of the 3D image is adjusted. At this point, as shown in (b) of FIG. 10, when the left image is shifted leftward and the right image is shifted rightward as much as the depth adjustment amount, the corresponding object appears to move further away from the viewer. Additionally, as shown in (c) of FIG. 10, when the left image and the right image are respectively shifted to opposite directions as much as the depth adjustment amount, the corresponding object appears to move closer to the viewer. Herein, the depth adjustment amount is obtained (or calculated) by the shift value calculation unit (232).

Additionally, for left/right images deviating from the reference depth range, the present invention may shift the corresponding images within the reference depth range, while, at the same time, shifting the left/right images in accordance with the reference level, which is selected by the user, based upon the reference point.

Meanwhile, the depth map extraction unit (141) calculates a final depth map (i.e., distance information of each pixel) through basic depth map extraction, elaboration, interpolation processes, and, then, the depth map extraction unit (141) outputs the calculated final depth map to the depth distribution analyzing unit (131) and the new viewpoint image synthesis unit (142).

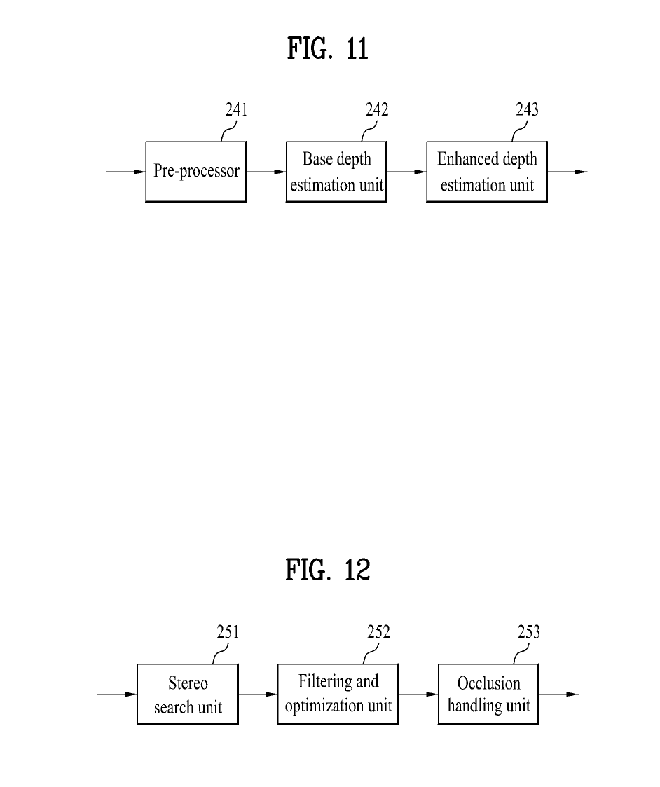

FIG. 11 illustrates a detailed block diagram showing the depth map extraction unit (141) according to an exemplary embodiment, and, herein, the depth map extraction unit (141) may include a pre-processor (241), a base depth estimation unit (242), and an enhanced depth estimation unit (243).

The pre-processor (241) estimates in advance a depth range or disparity range (distance information of each pixel along the Z-axis within the screen) by using images of at least one level of the image hierarchy, which is outputted from the stereo image analyzing unit (121). More specifically, the pre-processor (241) estimates a depth range before performing full-scale depth estimation from the image hierarchy of the stereo image. At this point, according to an exemplary embodiment of the present invention, the depth range is estimated by using an image having the same level as or a level lower than the level of the image, which is used by the base depth estimation unit (242) of a later end.

According to an exemplary embodiment, if the base depth estimation unit (242) calculates the base depth as a Level 2 image, the pre-processor (241) performs a SAD (Sum of Absolute Difference) from a Level 3 image, so as to approximate the depth range. Herein, SAD corresponds to an added value (or sum) of absolute values of a difference between pixel values located in the same position between two blocks, and, as the SAD becomes smaller, a level of similarity between the blocks becomes greater.

According to another exemplary embodiment, a depth range or disparity range may be obtained (or calculated) for each line. And, according to yet another exemplary embodiment, a depth range may also be calculated for each rectangular block, so as to be used for estimating the base depth. As described above, the present invention may calculate the depth range of a specific position by using diverse methods.

More specifically, in order to minimize any matching error that may occur while performing stereo matching, the present invention estimates in advance a search range in which an actual candidate may be generated through the pre-processor (241).

FIG. 12 illustrates a detailed block diagram showing the base depth estimation unit of FIG. 11 according to an exemplary embodiment, and, herein, the base depth estimation unit may include a stereo search unit (251), a filtering and optimization unit (252), and an occlusion handling unit (253).

In case the base depth estimation unit (242) estimates the depth range by using a Level 0 image (i.e., an original resolution stereo image), since the calculation amount becomes vast, the base depth estimation unit (242) estimates a base depth by using an image of a small size within the image hierarchy. According to an exemplary embodiment of the present invention, the base depth is estimated by using a Level 2 image.

In order to do so, the stereo search unit (251) calculates a level of similarity, such as SAD, in pixel or block units, which are intended to be compared between the left and right images within the disparity search range, and, then, pairs having the highest level of similarity are obtained. The difference between the x coordinate values of two pairs reflects the depth size (i.e., parallax). At this point, when the difference between the x coordinate values of two pairs is equal to 0, an object of the image appears to be on the screen, and, as the difference between the x coordinate values of two pairs becomes greater, the object of the image is either protruded more outside of the screen or sunk more into the screen.

The filtering and optimization unit (252) aligns the boundary of the object within the image with the boundary of the object within the depth map by using a filter. More specifically, when only the SAD is calculated, the boundary of the object within the depth map is marked in bolder lines than the boundary of the object within the image. In order to resolve this, the filtering and optimization unit (252) aligns the boundary of the object within the depth map and the boundary of the object within the image. At this point, according to an exemplary embodiment, when the level of similarity is compared by reflecting 2 items between blocks that are intended to be compared, a bilateral filter is used, and, when the level of similarity is compared by reflecting 3 items, a trilateral filter is used. According to the exemplary embodiment, when using the bilateral filter, the levels of similarity are compared by reflecting items, such as a color difference between two blocks that are intended to be compared and a difference value with the mean value, and, when using the trilateral filter, the levels of similarity are compared by reflecting items, such as a color difference between two blocks that are intended to be compared, a difference value with the mean value, and a difference value with the depth value.

Moreover, in addition to the neighboring information of the position that is intended to be calculated, the filtering and optimization unit (252) may also perform an optimization method of adjusting the current result, so that the result obtained from the whole frame can become the optimal result, by also using a correlation within the whole frame.

After detecting an occlusion region through a correspondence relation between the left/right depths, the occlusion handling unit (253) may use a filter (e.g., a bilateral filter or a trilateral filter, and so on), so as to newly obtain and update the depth of the occlusion region based upon the image information. For example, a case may occur, wherein an object or background that is seen in the left image may not be seen in the right image because the corresponding object or background is covered (or blocked) by another object. More specifically, in accordance with the time point, another object or background that is covered (or blocked) by a specific object depending upon the viewpoint is referred to as an occlusion region.

By deducing a valid depth range or candidate from the local region, such as a line or block, and so on, a disparity search range, which is used during the base depth estimation procedure, may reduce depth noise.

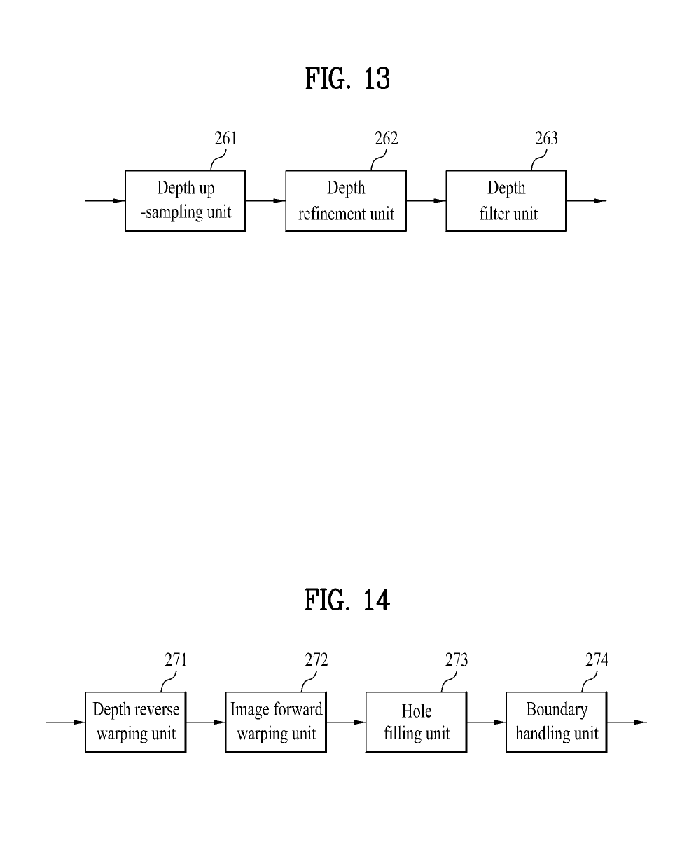

FIG. 13 illustrates a detailed block diagram showing the enhanced depth estimation unit (243) of FIG. 11 according to an exemplary embodiment, and, herein, the enhanced depth estimation unit (243) may include a depth up-sampling unit (261), a depth refinement unit (262), and a depth filter unit (263).

The enhanced depth estimation unit (243) enhances the base depth, which is estimated by the base depth estimation unit (242), to a resolution of a higher level. According to an exemplary embodiment of the present invention, enhancement is made to a depth of an original image resolution.

In order to do so, the depth up-sampling unit (261) up-samples the base depth of the level image, which is estimated by the base depth estimation unit (242), to a depth of a higher level image by using a filter. At this point, a linear filter, such as a bilinear filter, or an edge-preserving filter, such as a bilateral filter, may be used as the filter. For example, in case the base depth estimation unit (242) has estimated the base depth by using a Level 2 image, the depth up-sampling unit (261) performs up-sampling to a depth of a Level 1 image. Additionally, in case the depth up-sampling unit (261) has estimated the base depth by using a Level 1 image, the depth up-sampling unit (261) performs up-sampling to a depth of a Level 0 image.

The depth refinement unit (262) enhances depth precision by performing a local search in the surroundings of the depth value, which is up-sampled by the up-sampling unit (261).

The depth filter unit (263) eliminates (or cancels) noise of the depth having its precision increased by using a filter. The depth, i.e., depth map information of each pixel having its noise removed by the depth filter unit (263) is outputted to the new viewpoint image synthesis unit (142).

The new viewpoint image synthesis unit (142) modifies the original images, based upon depth map information being outputted from the depth map extraction unit (141) and a depth level being inputted through the depth adjusting UI unit (151), so as to generate an image of a wanted viewpoint. More specifically, the new viewpoint image synthesis unit (142) generates an image of a new viewpoint that best fits the depth level, which is inputted through the depth adjusting UI unit (151), by using the original image and the depth map information.

FIG. 14 illustrates a detailed block diagram showing the new viewpoint image synthesis unit (142) according to an exemplary embodiment of the present invention, and, herein, the new viewpoint image synthesis unit (142) may include a depth reverse warping unit (271), an image forward warping unit (272), a hole filling unit (273), and a boundary handling unit (274).

In order to obtain the depth from a new viewpoint position best-fitting the depth level, which is inputted through the depth adjusting UI unit (151), the depth reverse warping unit (271) performs warping on a depth map from left/right original image positions.

By shifting the original image pixel value to a position, which is indicated by the depth map of the new viewpoint, the image forward warping unit (272) configures an image of the new viewpoint (or new viewpoint image).

More specifically, by handling (or manipulating) the depth map, which is extracted by the depth map extraction unit (141), in accordance with the depth level, which is inputted by the user through the UI, and by shifting pixels of the original image to a depth corresponding to the handled depth map, the depth reverse warping unit (271) and the image forward warping unit (272) generates (synthesizes) a new viewpoint image. And, the new viewpoint image and the original image are outputted to the hole filling unit (273).

The hole filling unit (273) fills a hole region, which is formed (or generated) during the warping process. According to an exemplary embodiment, the hole region may be filled with a pixel value, which exists in the left/right images. According to another exemplary embodiment, in case of a hole that does not exist in either of the two images, the hole may be filled with color values that are already used for filling, by using a bilateral or trilateral filter and a color value similarity level, and a depth value similarity level. At this point, since a mixed region, wherein the background and the pixel units are not clearly distinctive, exists in the object boundary, after the warping process, a case may occur wherein the object remains in a portion of the background, or wherein a portion of the background remains in the object. At this point, a boundary change condition is checked by using information on the edge being warped, thereby being capable of processing the image.

The boundary handling unit (274) removes a massive hole region, which is generated at left/right boundaries of the image after performing the new viewpoint image synthesis. At this point, according to an exemplary embodiment, after deciding the portion, to which the boundary handling is to be applied, by analyzing a warping direction at the image left/right boundaries, the process is carried out by an order of applying boundary handling. As an example of boundary handling, the present invention proposes a method of stretching a predetermined region of the left/right boundaries of the depth map, so that the depth value can converge with 0. Thus, the massive hole region at the image boundary is covered by stretching an image region wherein a hole has not been generated. At this point, a predetermined region of the left/right boundaries of the depth map may be set up as a fixed value, or, by analyzing a Warping size of the image boundaries for each Horizontal Line, the value itself may be set up without modification, or settings may be made after an adequate modification.

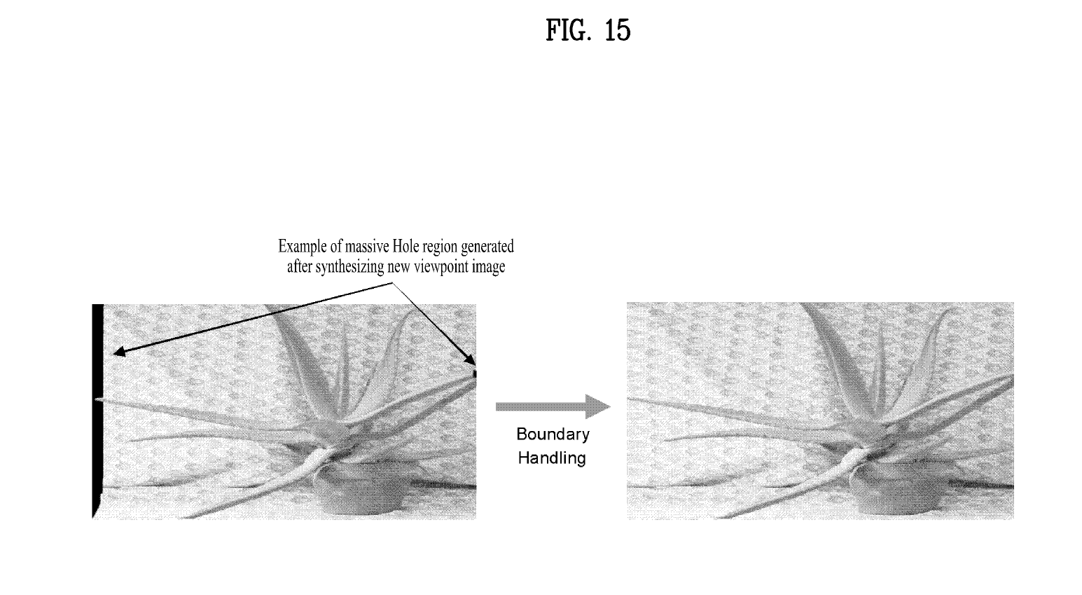

(a), (b) of FIG. 15 illustrate an example of boundary handling on a massive hole region, which is generated after performing a new viewpoint image synthesis. More specifically, the massive hole region formed in (a) of FIG. 15 will disappear (or be removed) after boundary handling, as shown in (b) of FIG. 15.

As described above, in the present invention, the depth level may be set up by the user through the depth adjusting UI unit (151), or the depth level may be automatically set up by the 3D image display device through an image analysis. And, the depth level, which is decided by the user, or which is automatically decided, is provided to the image shift adjusting unit (132) and/or the new viewpoint image synthesis unit (142).

The stereo image having its 3D effect adjusted by the image shift adjusting unit (132) and/or the new viewpoint image synthesis unit (142) is outputted to the formatter (105).

The formatter (105) converts any one of the stereo image having its 3D effect adjusted by the image shift adjusting unit (132) and the stereo image having its 3D effect adjusted by the new viewpoint image synthesis unit (142) to best fit the output format of the display device. For example, the formatter (105) performs a function of mixing the depth-adjusted left image and right image in line units.

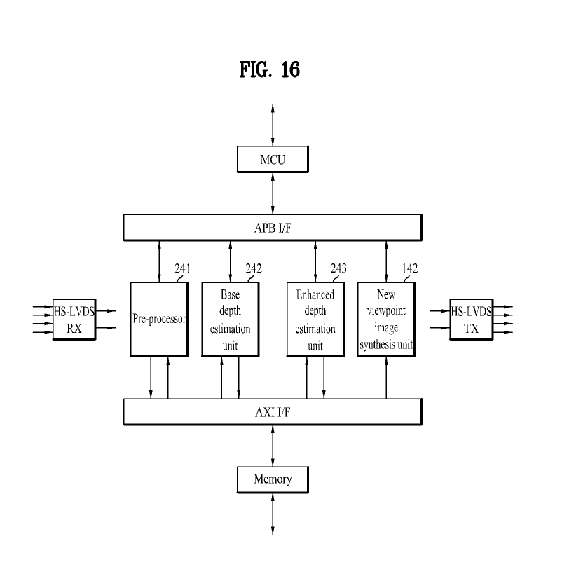

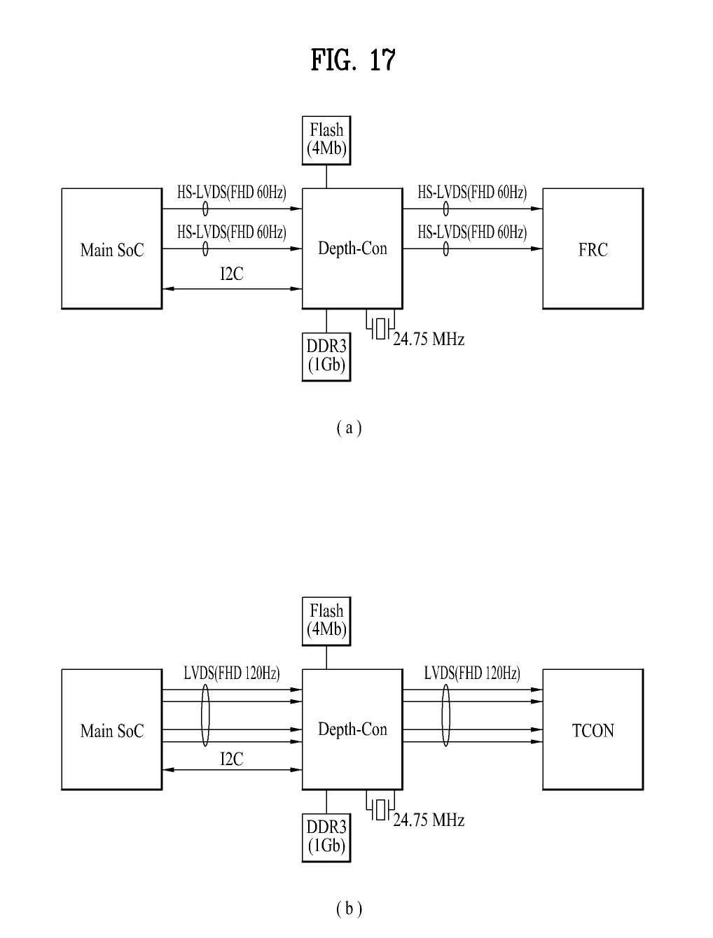

FIG. 16 illustrates a block diagram showing a hardware configuration of the device extracting a depth map and synthesizing a new viewpoint image, when realizing the present invention as an ASIC (Application Specific Integrated Circuit). More specifically, the left/right images are inputted through an interface input (e.g., HS-LVDS RX) terminal, and the inputted left/right images are inputted to the pre-processor (241) of the depth map extraction unit (141) through the stereo image analyzing unit (121). In FIG. 16, since detailed operations of the pre-processor (241), the base depth estimation unit (242), the enhanced depth estimation unit (243), and the new viewpoint image synthesis unit (142) have already been described above, the detailed description of the same will be omitted herein. At this point, the pre-processor (241), the base depth estimation unit (242), the enhanced depth estimation unit (243), and the new viewpoint image synthesis unit (142) may each independently communicate with a memory, thereby being capable of transmitting input and result values. The information required in each process may be delivered (or transferred) through a controller (Micro Controller Unit, MCU), and a predetermined portion of the calculation (or operation) process may be handled by the MCU. A result of one original image and one new viewpoint image may be outputted through an interface output (e.g., HS-LVDS TX) terminal.

(a), (b) of FIG. 17 illustrate exemplary configuration in a system of an ASIC with respect to the depth controller (104). Most particularly, (a) of FIG. 17 shows an example, wherein the ASIC for depth adjustment receives a stereo image from a main SoC at a dual full HD 60 Hz, adjusts its depth, and outputs the resulting image. At this point, according to an exemplary embodiment, an FRC (frame rate conversion) block converts a frame rate of the stereo image having its depth adjusted to a specific frame rate (e.g., 120 Hz) and outputs the converted image. (b) of FIG. 17 shows an example, wherein a stereo image is received in a 120 Hz frame-compatible format and, then, after adjusting the depth of the received image, the processed image is outputted Line-by-Line. At this point, according to an exemplary embodiment, a TCON (timing controller) block outputs the stereo image having its depth adjusted to the display device at the right timing.

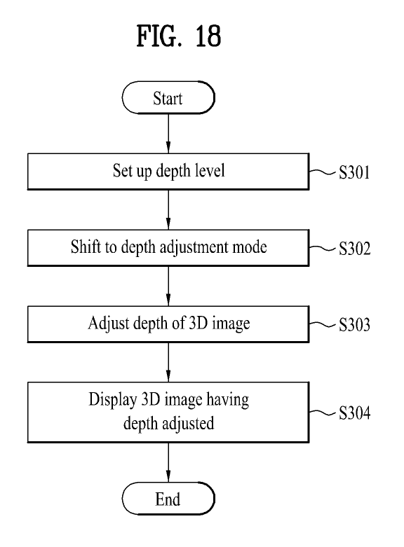

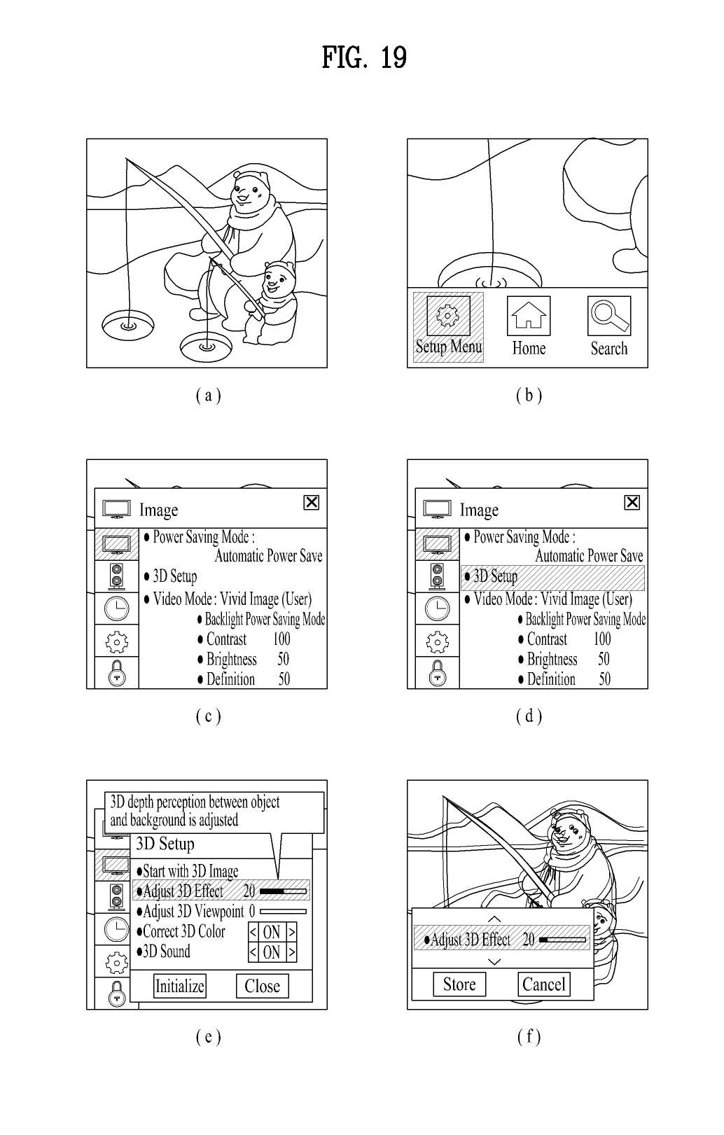

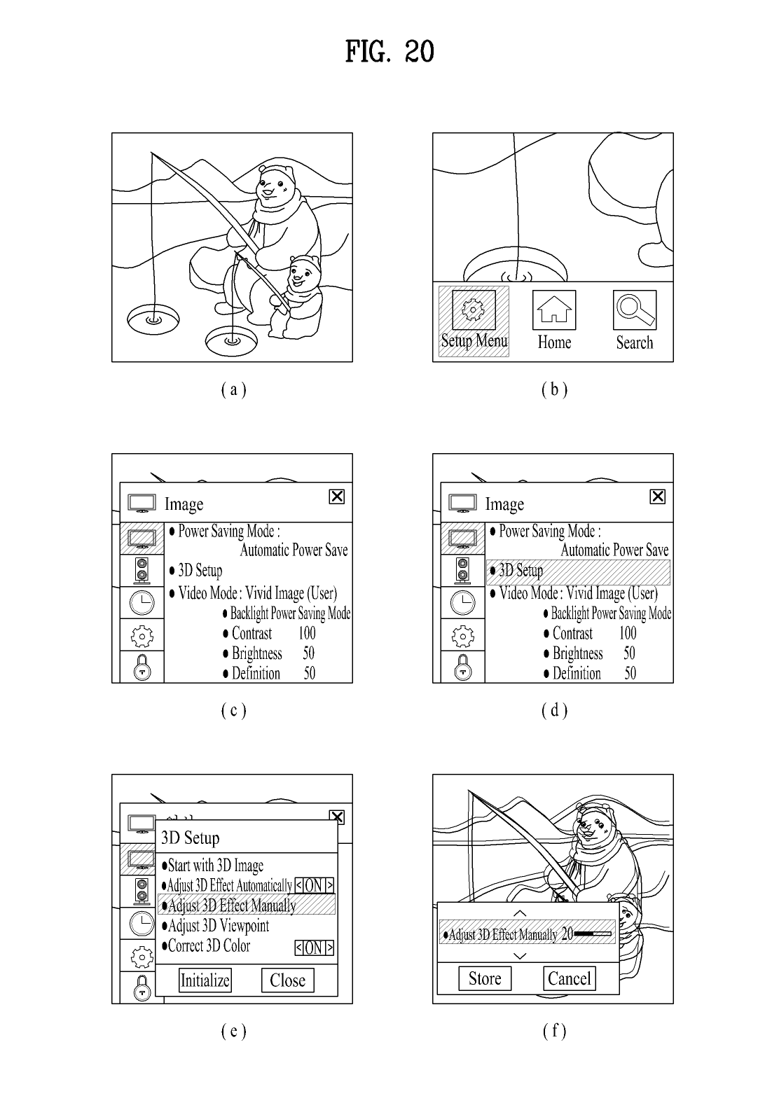

FIG. 18 illustrates a flow chart showing a method of adjusting 3D effect of a stereo image in a 3D image display device, such as a TV receiver, according to an exemplary embodiment of the present invention. According to the exemplary embodiment, in FIG. 18, the depth level is received through the depth adjusting UI unit (151).

Referring to FIG. 18, when the user selects a depth level through the depth adjusting UI unit (151) (S301), the 3D display device shifts to a depth adjustment mode (S302). For example, the depth adjustment mode operation starts from having the user select a wanted depth level from a 3D effect adjustment option, which is displayed on the menu, through a remote controller. At this point, a CPU, MCU within an image processing chip of the 3D image display device processes the depth adjusting UI, so as to shift to the depth adjustment mode. Subsequently, at least one of the first depth adjusting unit and the second depth adjusting unit is activated, so as to adjust the depth of the stereo image, which is being inputted or displayed (S303). Since detailed operations of the first depth adjusting unit and the second depth adjusting unit have already been described above, the detailed description of the same will be omitted herein. The stereo image having its depth adjusted in step 5303 is outputted to the display device through the formatter, so as to be displayed (S304). More specifically, the 3D image having its 3D effect adjusted in accordance with a depth level is displayed on the display device.

FIG. 19 shows a scenario for executing the depth adjusting UI in the 3D image display device. The user may perform from (a) to (f) of FIG. 19 in order to adjust the depth level.

(a) of FIG. 19 shows a current 3D image screen, and (b) of FIG. 19 shows an example of a system set-up menu option (or icon) being displayed a lower portion of the screen. (c) of FIG. 19 shows an example of menu options that are displayed when an image menu option is selected from several menu options that are displayed when the user selects the system set-up menu option. Referring to (c) of FIG. 19, when the user selects the system set-up menu option, it is apparent that a 3D set-up menu option is displayed. Then, when the user selects the 3D set-up menu option, as shown in (d) of FIG. 19, menu items related to the 3D set-up are indicated, as shown in (e) of FIG. 19. For example, the menu options related to the 3D set-up may correspond to a Start with 3D image menu option, a 3D effect adjustment menu option, a 3D viewpoint adjustment menu option, a 3D color correction menu option, and a 3D sound menu option, and so on. At this point, when the user selects the 3D effect adjustment menu option, a screen that can set up the depth level is displayed, as shown in (f) of FIG. 19. For example, in the screen as shown in (e) of FIG. 19, when the user moves a cursor on the 3D effect adjustment menu option, a help information, such as “3D depth perception between object and background is adjusted”, which describes the function of the selected menu option, may be displayed in the form of a text bubble. Additionally, as shown in (e) of FIG. 19, the depth level of the current frame (or the current image displayed behind the menu options) may be shown be using a horizontal bar.

For example, in (f) of FIG. 19, the user may select one depth level from depth levels 0-20, and it may be shown behind the menu that the 3D effect of the 3D image is being adjusted to best fit the selected depth level. At this point, according to an exemplary embodiment, when the user selects a Store option, the 3D image having its depth (i.e., 3D effect) adjusted is displayed on the display device, and, when the user selects a Cancel option, a previous 3D image prior to having its depth (i.e., 3D effect) adjusted is displayed on the display device.

Meanwhile, as an additional UI, the present invention may apply 2 different modes for depth adjustment. More specifically, between an automatic mode and a manual (or user) mode, the user may select one of the two modes. In the manual mode, detailed setting of the above-mentioned UI may be adjusted by the user, and, in case of the automatic mode, the user may select only one of automatic mode on (i.e., being turned on)/off (i.e., being turned off), and, if the user selects the automatic mode on (i.e., being turned on), adjustments may be automatically made so that an adequate 3D effect can be experienced in accordance with the contents by applying the depth adjustment values and the image shift values, which have already been extracted earlier.

FIG. 20 shows a scenario for executing the depth adjusting UI in the 3D image display device adopting an automatic mode and a manual mode for adjusting the 3D effect of the 3D image. The user may perform from (a) to (f) of FIG. 20 in order to adjust the depth level. At this point, since the description of (a) of FIG. 20 to (d) of FIG. 20 is identical to the description of (a) of FIG. 19 to (d) of FIG. 19, detailed description of the same will be omitted herein.

Referring to (e) of FIG. 20, it is shown that both 3D effect automatic adjustment menu options and 3D effect manual adjustment menu options are displayed. At this point, the user may select turn on (On) or turn off (Off) options from the 3D effect automatic adjustment menu options, and, when the user selects the turn on option, the 3D image display device automatically adjusts the effect of the 3D image. For example, when the 3D image deviates from the reference level range, the corresponding image may be shifted within the reference level range. In another example, the reference point may be forcibly shifted to 0. Meanwhile, if the user selects the 3D effect manual adjustment menu options, a screen for allowing the user to set up the depth level is displayed, as shown in (f) of FIG. 20. For example, the reference value may be shifted to a specific value in accordance with the depth level, which is set up by the user. Also, in (f) of FIG. 20, when the user selects a Store option, the 3D image having its depth (i.e., 3D effect) adjusted is displayed on the display device, and, when the user selects a Cancel option, a previous 3D image prior to having its depth (i.e., 3D effect) adjusted is displayed on the display device. According to the exemplary embodiment, parts that are not described in FIG. 20 follow the respective description of FIG. 19.

As described above, the description of the present invention will not be limited only to the above-described exemplary embodiments, and, as it will be apparent from the appended claims, the present invention may be modified by anyone skilled in the art, and such modification will not depart from the spirit or scope of the present invention.

### MODE FOR CARRYING OUT THE PRESENT INVENTION

As described above, the related details have been described in the best mode for carrying out the present invention.

### INDUSTRIAL APPLICABILITY

As described above, in addition to TV receivers, the present invention may be applied to all devices displaying 3D images.

What is claimed is:

1. A 3D image display device, comprising:
a stereo image analyzing unit configured to receive a stereo image that is composed of a left image and a right image and to detect image information including at least one of edge information, color information, and scene change information;
a first depth adjusting unit configured to decide a reference point by analyzing a depth distribution of the stereo image based upon the detected image information, and to adjust 3D effect of the stereo image by shifting the stereo image based upon the decided reference point;
a second depth adjusting unit configured to extract depth map information in pixel units after reducing a size of the stereo image, and to adjust 3D effect of the stereo image by warping the extracted depth map information and generating a new viewpoint image; and
a formatter configured to convert a format of a stereo image having its 3D effect adjusted to best fit the display device, wherein the stereo image having its 3D effect is adjusted by at least one of the first depth analyzing unit and the second depth analyzing unit.

2. The device of claim 1, wherein the stereo image analyzing unit configures multiple level images by sequentially reducing the stereo image to predetermined sizes, and wherein the stereo image analyzing unit detects the image information including at least one of the edge information, the color information, and the scene change information from at least one level image of the multiple level images.

3. The device of claim 2, wherein the first depth adjusting unit comprises:
a depth distribution analyzing unit configured to configure a depth histogram indicating depth distribution of the stereo image by extracting feature corresponding points respective to the left image and the right image within the stereo image based upon the image information, and to decide the reference point from the depth histogram; and
an image shift adjusting unit configured to adjust 3D effect of the stereo image by shifting the stereo image based upon the decided reference point.

4. The device of claim 3, wherein the depth distribution analyzing unit receives the depth map information in pixel units from the second depth adjusting unit, so as to configure the depth histogram indicating depth distribution of the stereo image, and wherein the depth distribution analyzing unit decides the reference point from the depth histogram.

5. The device of claim 3, wherein the image shift adjusting unit comprises:
a depth range analyzing unit configured to add weight of a depth statistics value of a previous frame to the reference point decided by the depth distribution analyzing unit, thereby reconfiguring the reference point; and
a shift value calculation unit configured to shift the stereo image, after calculating a shift value according to which the stereo image is to be shifted based upon the reconfigured reference point and depth level.

6. The device of claim 5, wherein the depth level is set up by a user through a user interface (UI), or wherein the depth level is automatically set up by the 3D image display device.

7. The device of claim 3, wherein the image shift adjusting unit shifts the stereo image within a predetermined reference depth range when the stereo image deviates from the predetermined reference depth range.

8. The device of claim 1, wherein the second depth adjusting unit comprises:
a depth map extraction unit configured to estimate depth map information for each pixel from a stereo image corresponding to a level lower than a resolution of an original image and to up-sample the depth map information to the resolution of the original image; and
a new viewpoint image synthesis unit configured to generate the new viewpoint image by warping the depth map information.

9. The device of claim 8, wherein the depth map extraction unit comprises:
a pre-processor configured to estimate a search range by estimating depth map information of each pixel from a second level stereo image;
a base depth estimation unit configured to estimate base depth map information of each pixel from a first level stereo image within the estimated search range; and
an enhanced depth estimation unit configured to up-sample the base depth map information to the resolution of the original image.

10. The device of claim 8, wherein the new viewpoint image synthesis unit comprises:
a warping unit configured to warp the depth map information in accordance with depth levels, and to generate the new viewpoint image based upon the warped depth map information;
a hole filling unit configured to fill holes generated during the warping process; and
a boundary handling unit configured to remove hole regions generated at a boundary of the new viewpoint image.

11. A method for displaying a 3D image in a 3D image display device, the method comprising:
a stereo image analyzing step receiving a stereo image that is composed of a left image and a right image and detecting image information including at least one of edge information, color information, and scene change information;
a first depth adjusting step deciding a reference point by analyzing a depth distribution of the stereo image based upon the detected image information, and adjusting 3D effect of the stereo image by shifting the stereo image based upon the decided reference point;
a second depth adjusting step extracting depth map information in pixel units after reducing a size of the stereo image, and adjusting 3D effect of the stereo image by warping the extracted depth map information and generating a new viewpoint image; and
a format converting step converting a format of a stereo image having its 3D effect adjusted to best fit the display device, wherein the stereo image having its 3D effect is adjusted by at least one of the first depth analyzing step and the second depth analyzing step.

12. The method of claim 11, wherein the stereo image analyzing step configures multiple level images by sequentially reducing the stereo image to predetermined sizes, and wherein the stereo image analyzing step detects the image information including at least one of the edge information, the color information, and the scene change information from at least one level image of the multiple level images.

13. The method of claim 12, wherein the first depth adjusting step comprises:
a depth distribution analyzing step configuring a depth histogram indicating depth distribution of the stereo image by extracting feature corresponding points respective to the left image and the right image within the stereo image based upon the image information, and deciding the reference point from the depth histogram; and
an image shift adjusting step adjusting 3D effect of the stereo image by shifting the stereo image based upon the decided reference point.

14. The method of claim 13, wherein the depth distribution analyzing step receives the depth map information in pixel units from the second depth adjusting unit, so as to configure the depth histogram indicating depth distribution of the stereo image, and wherein the depth distribution analyzing step decides the reference point from the depth histogram.

15. The method of claim 13, wherein the image shift adjusting step comprises:
a step of reconfiguring the reference point, by adding weight of a depth statistics value of a previous frame to the reference point decided by the depth distribution analyzing step, thereby reconfiguring the reference point; and
a step of shifting the stereo image by shifting the stereo image, after calculating a shift value according to which the stereo image is to be shifted based upon the reconfigured reference point and depth level.

16. The method of claim 15, wherein the depth level is set up by a user through a user interface (UI), or wherein the depth level is automatically set up by the 3D image display device.

17. The method of claim 13, wherein the image shift adjusting step further comprises:
a step of shifting the stereo image within a predetermined reference depth range, when the stereo image deviates from the predetermined reference depth range.

18. The method of claim 11, wherein the second depth adjusting step comprises:
a depth map extracting step estimating depth map information for each pixel from a stereo image corresponding to a level lower than a resolution of an original image, and up-sampling the depth map information to the resolution of the original image; and
a new viewpoint image synthesizing step generating the new viewpoint image by warping the depth map information.

19. The method of claim 18, wherein the depth map extracting step comprises:
a step of estimating a search range by estimating depth map information of each pixel from a second level stereo image;
a step of estimating base depth map information of each pixel from a first level stereo image within the estimated search range; and
a step of up-sampling the base depth map information to the resolution of the original image.

20. The method of claim 18, wherein the new viewpoint image synthesizing step comprises:
a step of warping the depth map information in accordance with depth levels and generating the new viewpoint image based upon the warped depth map information;
a step of filling holes generated during the warping process; and
a step of removing hole regions generated at a boundary of the new viewpoint image.
